(19) United States
(12) Patent Application Publication
(10) Pub. No.: US 2018/0052903 A1
(43) Pub. Date: Feb. 22, 2018

(54) TRANSFORMING HISTORICAL WELL PRODUCTION DATA FOR PREDICTIVE MODELING

(71) Applicant: Halliburton Energy Services, Inc., Houston, TX (US)

(72) Inventors: Ivette A. Mercado, Humble, TX (US); Dwight Fulton, Cypress, TX (US)

(21) Appl. No.: 14/911,005

(22) PCT Filed: May 15, 2015
(86) PCT No.: PCT/US15/31191

§ 371 Date: Feb. 8, 2016

(51) Int. Cl. G06F 17/30; G06F 17/15

(52) U.S. Cl. CPC G06F 17/30598; E21B 47/12; G06F 17/15; G06F 17/30303

(57) ABSTRACT

System and methods for transforming well production data for predictive modeling are provided. Aggregated production data for one or more wells in a hydrocarbon producing field is pre-processed in order to generate clusters of the production data, based on a set of uncontrollable production variables identified for the wells. The pre-processed production data within each of the clusters is standardized based on clustering parameters calculated for each cluster. The standardized production data within each of the clusters is then used to generate transactional data for use in a predictive model for estimating future production from the one or more wells.

### FIELD OF THE DISCLOSURE

The present disclosure relates generally to data processing and analysis and, more specifically, to data processing and analysis tools for predictive modeling of future hydrocarbon production from wells in a field based on historical well production data.

### BACKGROUND

Various modeling techniques are commonly used in the design and analysis of hydrocarbon exploration and production operations. For example, a geologist or reservoir engineer may use a geocellular model or other physics-based model of an underground formation to make decisions regarding the placement of production or injection wells in a hydrocarbon producing field or across a region encompassing multiple fields. In addition, numerical data models may be used in conjunction with different statistical methods for is estimating or predicting future hydrocarbon production from the wells once they have been drilled into the underground formation. The accuracy of the prediction may be dependent upon the model's capability to detect relevant variables associated with wellsite operations in the field or region, which have the greatest impact on production.

However, the detection of such variables is usually difficult due to the different types of variables that may be detected. For example, the types of variables impacting production from a well generally include uncontrollable variables and controllable variables. Uncontrollable variables are fixed variables that cannot be adjusted, for example, as part of a configurable option for a stimulation treatment. Controllable variables on the other hand are adjustable, e.g., for purposes of controlling production from the well going forward. However, as some controllable variables are inherent to the nature of the hydrocarbon recovery process itself, such variables may be so dominant that they obscure the effect of other controllable variables of interest.

### BRIEF DESCRIPTION OF THE DRAWINGS

FIG. 1 is a perspective view of a portion of a hydrocarbon producing field according to an embodiment of the present disclosure.

FIG. 2 is a block diagram of an exemplary computer system for processing historical production data acquired from one or more wellsites in the hydrocarbon producing field of FIG. 1.

FIG. 3 is a flow diagram of an exemplary process for transforming well production data for use in predictive modeling.

FIG. 4 is a flow diagram of an exemplary pre-processing stage of the transformation process of FIG. 3.

FIG. 5 is a flow diagram of an exemplary process for normalizing uncontrollable variables identified during the pre-processing stage of FIG. 4.

FIG. 6 is a flow diagram of an exemplary process for clustering the production data based on the uncontrollable variables during the pre-processing stage of FIG. 4.

FIG. 7 is a flow diagram of an exemplary process for standardizing the pre-processed production data following the pre-processing stage of FIG. 4.

FIG. 8 is a block diagram of an exemplary computer system in which embodiments of the present disclosure may be implemented.

### DESCRIPTION OF ILLUSTRATIVE EMBODIMENTS

Embodiments of the present disclosure relate to transforming well production data for improved predictive modeling. While the present disclosure is described herein with reference to illustrative embodiments for particular applications, it should be understood that embodiments are not limited thereto. Other embodiments are possible, and modifications can be made to the embodiments within the spirit and scope of the teachings herein and additional fields in which the embodiments would be of significant utility.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described. It would also be apparent to one skilled in the relevant art that the embodiments, as described herein, can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

As noted above, embodiments of the present disclosure relate to transforming well production data for improved predictive modeling. In one example, the disclosed embodiments may be used to transform historical well production data for use in a predictive model of future hydrocarbon production for one or more wells in a hydrocarbon producing field or wells across multiple fields in a geographic region. The predictive model may be, for example, any type of numerical model for estimating or predicting the future hydrocarbon production based on the transformed data. As will be described in further detail below, the well production data may be transformed so as to improve the detectability of different types of variables that impact production. Such variables may be related, for example, to the products or processes involved in a production operation or stimulation treatment for stimulating production through fluid injection.

As used herein, the term “controllable variables” refers to variables that may impact hydrocarbon production from a well and that are adjustable by a user, e.g., for purposes of improving production based on the analysis of production data obtained for the well. Examples of controllable variables may include, but are not limited to, adjustable properties or design options associated with a stimulation treatment.

In contrast, the term “uncontrollable variables” is used herein to refer to fixed variables that may impact production and that are not adjustable by the user. Examples of uncontrollable variables may include, but are not limited to, geographic or physical parameters associated with a well. Such parameters may include, for example and without limitation, one or more of a geographic location of each of the one or more wells, a total vertical depth of a wellbore drilled at each of the one or more wells, and a bottom hole reservoir pressure within the wellbore at each of the one or more wells.

In an embodiment, aggregated well production data, e.g., in the form of a time-series production values, may be transformed such that uncontrollable variables impacting production are incorporated. The transformed data may be grouped into clusters based on the uncontrollable variables and standardized to magnify impact of causal variables in the model. This allows for variations in production due to the different types of variables to be accounted for and the quality of the data to be improved for purposes of comparative analysis and better detection of these variables in the predictive model.

Embodiments of the present disclosure may be used, for example, as an essential preparatory mechanism for complex multivariate analysis to determine the relationship between well production and reservoir, wellbore, completion, and treatment parameters. Further, the disclosed embodiments may benefit petroleum engineering teams by providing team members with a capability to understand the impact of stimulation products and processes on production and use that understanding to drive idea generation and the development of new, customized solutions. Moreover, the data transformation techniques disclosed herein may be encapsulated within a standard data analysis and modeling application executable at a user's computing device, in which complex statistical analysis and modeling features can be implemented in the background and kept hidden from the user. For example, such an application may provide the user with access to sophisticated production data analysis functionality via a relatively straightforward/simplified user interface that does not require the user to have any formal training or particular background in statistical, modeling or data sciences. This would also save the user considerable time and effort in gathering and cross-checking multiple data sources for data mining and analysis purposes.

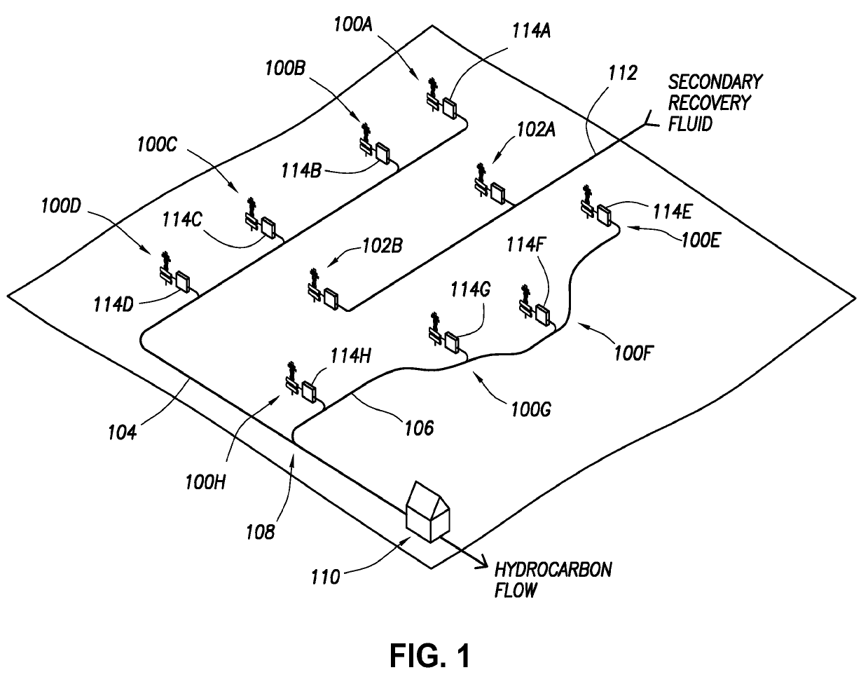

Other features and advantages of the disclosed embodiments will be or will become apparent to one of ordinary skill in the art upon examination of the following figures and detailed description. It is intended that all such additional features and advantages be included within the scope of the disclosed embodiments. Illustrative embodiments and related methodologies of the present disclosure are described below in reference to FIGS. 1-8. The examples illustrated in the figures are only exemplary and are not intended to assert or imply any limitation with regard to the environment, architecture, design, or process in which different embodiments may be implemented.

FIG. 1 is a perspective view of a portion of a hydrocarbon producing field according to an embodiment of the present disclosure. As shown in FIG. 1, the hydrocarbon producing field includes, for example, a plurality of hydrocarbon production wells 100A to 100H (“production wells 100A-H”) drilled at various locations throughout the field for recovering hydrocarbons from a subsurface reservoir formation. The field also includes injection wells 102A and 102B (“injection wells 102A-B”) for stimulating hydrocarbon production through injection of secondary recovery fluids, such as water or compressed gas, e.g., carbon dioxide, into the subsurface formation. The location of each well in this example may have been set by a wellsite operator, e.g., according to a predetermined wellsite plan to increase the extraction of hydrocarbons from the subsurface reservoir formation. It should be noted that the number of wells shown in the hydrocarbon producing field of FIG. 1 is merely illustrative and that the disclosed embodiments are not intended to be limited thereto.

In order to gather the produced hydrocarbons for sale, the hydrocarbon field has one more production flow lines (or “production lines”). In FIG. 1, a production line 104 gathers hydrocarbons from production wells 100A-100D, and a production line 106 gathers hydrocarbons from production wells 100E-100H. The production lines 104 and 106 tie together at a gathering point 108, and then flow to a metering facility 110.

In some cases, the secondary recovery fluid is delivered to injection wells 102A and 102B by way of trucks, and thus the secondary recovery fluid may only be pumped into the formation on a periodic basis (e.g., daily, weekly). In other cases, and as illustrated in FIG. 1, the second recovery fluid is provided under pressure to injection wells 102A and 102B by way of pipes 112.

As shown in the example of FIG. 1, production wells 100A-H may be associated with corresponding wellsite data processing devices 114A-H located at the surface of each wellsite. As will be described in further detail below, each of data processing devices 114A-H may be used to process and store data collected by various downhole and surface measurement devices for measuring the flow of hydrocarbons at each wellsite. The measurement devices may be of any of various types and need not be the same for all of production wells 100A-H. In some cases, the measurement device may be related to the type of artificial lift employed (e.g., electric submersible, gas lift, pump jack). In other cases, the measurement device on each of production wells 100A-H may be selected based on a particular quality of the well's hydrocarbon production, e.g., a tendency to produce hydrocarbons with excess water content.

In some implementations, one or more of the measurement devices may be in the form of a multi-phase flow meter. A multi-phase flow meter has the ability to not only measured hydrocarbon flow from a volume standpoint, but also give an indication of the mixture of oil and gas in the flow. One or more of the measurement devices may be oil flow meters, having the ability to discern oil flow, but not necessarily natural gas flow. One or more of the measurement devices may be natural gas flow meters. One or more of the measurement devices may be water flow meters. One or more of the measurement devices may be pressure transmitters measuring the pressure at any suitable location, such as at the wellhead, or within the borehole near the perforations.

In the case of measurement devices associated with artificial lift, the measurement devices may be voltage measurement devices, electrical current measurement devices, pressure transmitters measuring gas lift pressure, frequency meter for measuring frequency of applied voltage to electric submersible motor coupled to a pump, and the like. Moreover, multiple measurement devices may be present on any one hydrocarbon producing well. For example, a well where artificial lift is provided by an electric submersible pump may have various devices for measuring hydrocarbon flow at the surface, and also various devices for measuring performance of the submersible motor and/or pump. As another example, a well where artificial lift is provided by a gas lift system may have various devices for measuring hydrocarbon flow at the surface, and also various measurement devices for measuring performance of the gas lift system.

In an embodiment, the information collected by the measurement device(s) at each wellsite may be processed and stored at a data store of each of data processing devices 114A-H. In some implementations, collected measurements from each measurement device may be provided to each of data processing devices 114A-H as a stream of data, which may be indexed as a function of time and/or depth before being stored at the data store of the respective data processing devices 114A-H. The indexed data may include, for example, collected measurements of well stimulation treatment parameters, such as types of materials used during different stages of stimulation, quantities of materials applied during the stimulation, rates at which materials were applied during the stimulation, pressures of application, and various cycles of stimulation treatments applied to a well. In another example, indexed data may include measured drilling parameters, such as drilling fluid pressure at the surface, flow rate of drilling fluid, and rotational speed of the drill string in revolutions per minute (RPM). The indexed data may be stored in any of various data formats. For example, measurement-while-drilling (MWD) or logging-while-drilling (LWD) data may be stored in an extensible markup language (XML) format, e.g., in the form of wellsite information transfer standard markup language (WITSML) documents organized and/or indexed against time/depth. Other types of data related to the stimulation, drilling or production operations at each wellsite may be stored in a non-time-indexed format, such as in a format associated with a particular relational database. In other cases, historical production data for each of production wells 100A-H may be stored in a binary format from which pertinent information may be extracted for data mining and analysis purposes.

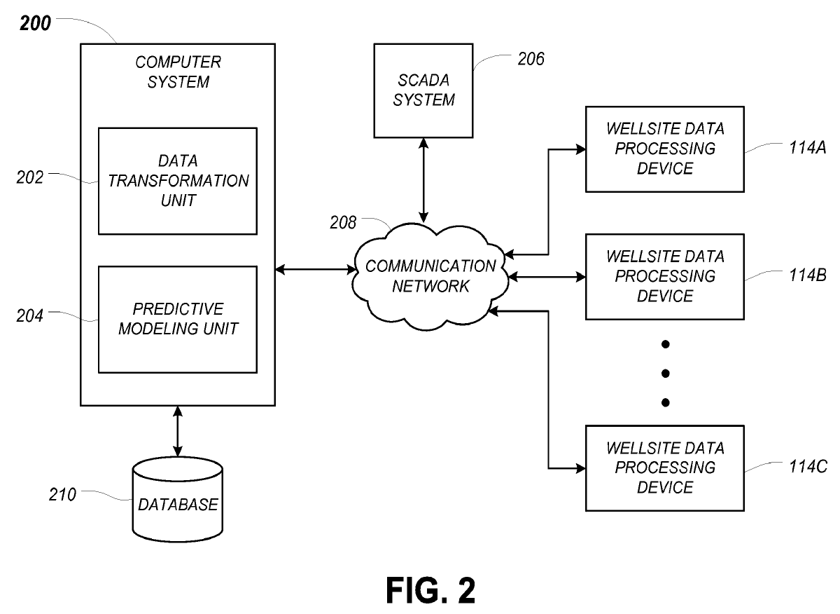

FIG. 2 is a block diagram of an exemplary computer system 200 for processing historical production data acquired from one or more wellsites in the hydrocarbon producing field of FIG. 1. However, it should be noted that system 200 is described using the field of FIG. 1 for discussion purposes only and is not intended to be limited thereto. In an embodiment, system 200 includes a data transformation unit 202 and a predictive modeling unit 204 for processing historical production data associated with production wells 100A-H of FIG. 1, as described above. System 200 may be implemented using any type of computing device having at least one processor and a memory. The memory may be in the form of a processor-readable storage medium for storing data and instructions executable by the processor. Examples of such a computing device include, but are not limited to, a tablet computer, a laptop computer, a desktop computer, a workstation, a server, a cluster of computers in a server farm or other type of computing device.

In some implementations, system 200 may be a server system located at a data center associated with the hydrocarbon producing field or region. The data center may be, for example, physically located on or near the field. Alternatively, the data center may be at a remote location that is some distance, e.g., many hundreds or thousands of miles, away from the hydrocarbon producing field or region. As shown in FIG. 2, system 200 may be communicatively coupled to a supervisory control and data acquisition (SCADA) system 206, a data store 210 and wellsite data processing devices 114A-H, as described above, via a communication network 208. Network 208 can be any type of network or combination of networks used to communicate information between different computing devices. Network 208 can include, but is not limited to, a wired (e.g., Ethernet) or a wireless (e.g., Wi-Fi or mobile telecommunications) network. In addition, network 208 can include, but is not limited to, a local area network, medium area network, and/or wide area network such as the Internet.

In an embodiment, system 200 may use network 208 to communicate with SCADA system 206 or wellsite data processing units 114A-H or a combination thereof to obtain well production data for predicting future hydrocarbon production for one or more of production wells 100A-H of the hydrocarbon producing field of FIG. 1, as described above. For example, SCADA system 206 may include a database (not shown) for storing well production data obtained for production wells 100A-H from wellsite data processing systems 114A-H, respectively, via network 208. System 200 in this example may communicate with SCADA system 206 via network 208 to obtain production data for one or more of production wells 100A-H. Alternatively, the production data upon which predictions as to future hydrocarbon flow are made may be obtained by system 200 directly from one or more of wellsite data processing devices 114A-H via network 208.

In an embodiment, the well production data obtained by system 200 (either from SCADA 206 or directly from wellsite data processing devices 114A-H) may be stored in database 210 for later access and retrieval. Database 210 may be any type of data storage device, e.g., in the form of a recording medium coupled to an integrated circuit that controls access to the recording medium. The recording medium can be, for example and without limitation, a semiconductor memory, a hard disk, or similar type of memory or storage device. The production data stored within database 210 may include, for example, historical production data that has been aggregated over a period of time for one or more of production wells 100A-H. The aggregated production data may be in the form of time-series data including, for example, a series of production values for one or more of production wells 100A-H at predetermined production increments during the period of time (e.g., hourly, daily, monthly, or at evenly spaced 30-day, 60-day or 90-day production time increments).

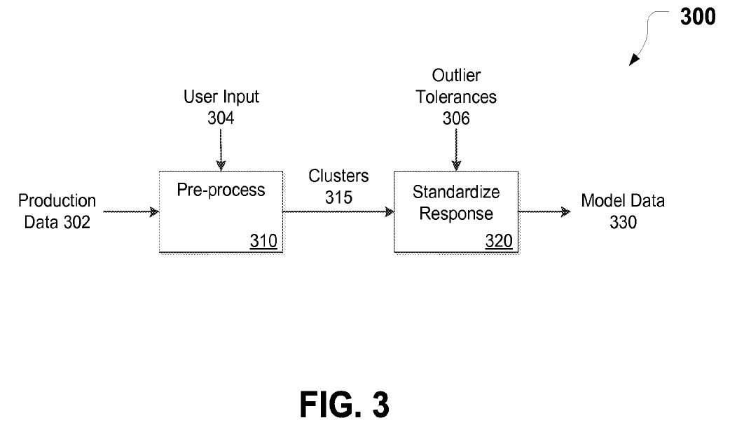

In an embodiment, relevant well production data may be retrieved from database 210 and provided as input to data transformation unit 202. Data transformation unit 202 may use a multi-stage process to transform the time-series well production data into transactional model data for use by predictive modeling unit 204. In an embodiment, the transformation process used by data transformation unit 202 may involve transforming well production data based on a set of uncontrollable variables identified for one or more of production wells 100A-H. An example of such a transformation process will be described in further detail below with respect to FIG. 3. In an embodiment, the uncontrollable variables may be identified based on input received from a user of system 200 via, for example, a user input device (not shown) coupled to system 200. Examples of such user input device include, but are not limited to, a mouse, keyboard, microphone, touch-pad or touch-screen display device coupled to system 200.

In an embodiment, predictive modeling unit 204 may use the model data produced by data transformation unit 202 to estimate or predict future hydrocarbon production of one or more of production wells 100A-H. For example, predictive modeling unit 204 may apply the data to any of various numerical models for predicting future hydrocarbon production from a specific production well of interest or from the hydrocarbon producing field or region overall, including all of the production wells within the field or region. Such a predictive model may be updated periodically based on, for example, new production data obtained from the production well(s) in the hydrocarbon producing field or region. In some implementations, new production data from the field or region may be transformed by data transformation unit 202 and applied to the model in real-time in order to produce updated predictions of future hydrocarbon production as the well production data changes over time. The results of the predictive modeling may be presented to the user of computer system 200 via, for example, a display device (not shown) coupled to system 200.

FIG. 3 is a flow diagram of an exemplary process 300 for transforming historical well production data for use in predictive modeling. As shown in FIG. 3, process 300 includes a pre-processing stage 310 and a response standardization stage 320. The input to pre-processing stage 310 may include well production data 302 and user input 304, e.g., input from the user of system 200 of FIG. 2, as described above. Well production data 302 may include production data obtained for one or more wells in a hydrocarbon producing field, e.g., one or more of production wells 100A-H of FIG. 1, as described above. In an embodiment, well production data 302 may have been aggregated over a period of time so that it is in the form of a series of production values in uniform production time increments (e.g., 30-day, 60-day, 90-day, etc.) spanning the period of time. As will be described in further detail below, user input 304 may be used by pre-processing stage 310 to identify controllable and uncontrollable variables associated with the one or more wells associated with the well production data 302 being transformed.

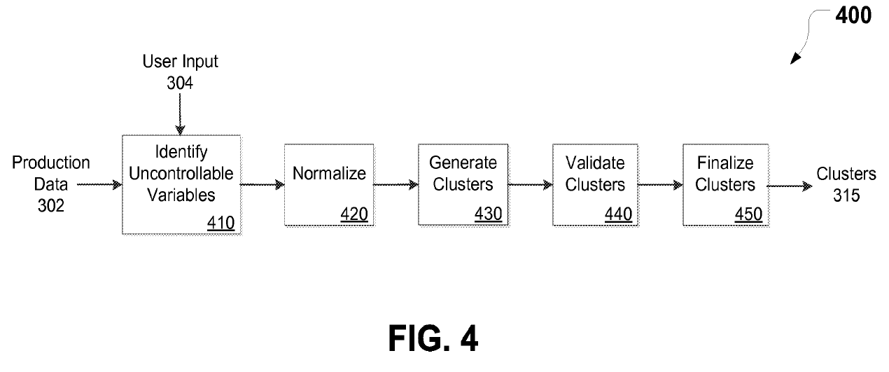

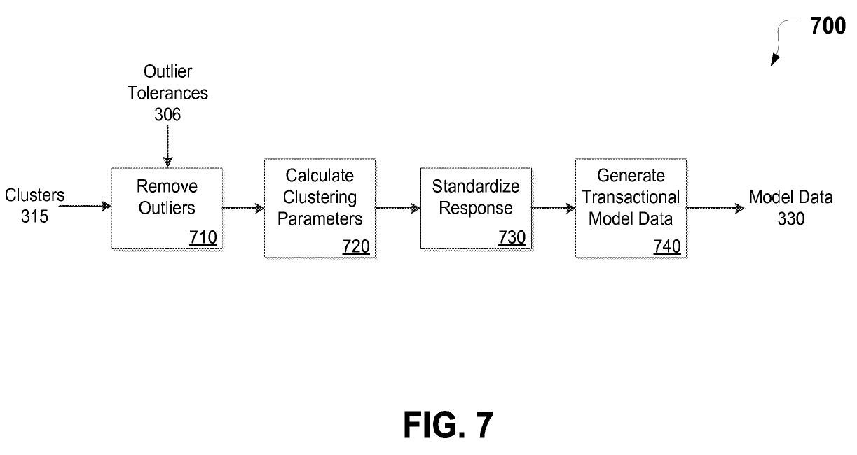

The output of pre-processing stage 310 may include a plurality of clusters 315 of production data 302. Pre-processing stage 310 and the clustering of production data 302 will be described in further detail below with respect to FIG. 4. The production data clusters 315 are then provided as input to stage 320, which standardizes the response (or output) for predictive modeling purposes based on one or more outlier tolerances 306. In an embodiment, the response is standardized by standardizing the pre-processed production data within each of clusters 315 based on one or more clustering parameters calculated for each cluster. Additional details regarding the response standardization in stage 320 will be described further below with respect to FIG. 7. In an embodiment, model data 330 may be generated based on the standardized production data within each of clusters 315. Model data 330 may include, for example, transactional data to be used in a predictive model for estimating or predicting future hydrocarbon production from the one or more wells.

FIG. 4 is a flow diagram of an exemplary process 400 for pre-processing the aggregated production data 302 associated with the one or more wells, as described above. Process 400 may be used, for example, to implement pre-processing stage 310 of transformation process 300 of FIG. 3. As shown in FIG. 4, process 400 includes steps 410, 420, 430, 440 and 450. Process 400 begins in step 410, which includes identifying one or more uncontrollable variables for the well(s). As described above, such uncontrollable variables may include, for example, any of various geographical or physical parameters associated with the individual well(s) in this example. Examples of the uncontrollable variables that may be identified include, but are not limited to, the geographic location (e.g., latitude and longitude coordinates or an elevation) of each of the one or more wells, a total vertical depth of each well, and a bottom hole reservoir pressure associated with each well.

Also, as described above, the uncontrollable variables may be identified for the one or more wells based on user input 304. For example, a list of known variables associated with the well(s) or related portion of the hydrocarbon producing field or region may be presented to the user, e.g., via the above-described display device coupled to system 200. The known variables for the well(s) may be included, for example, as part of production data 302 or other context data associated with the well(s) in this example. The user may specify the uncontrollable variables by selecting them directly from the displayed list, e.g., via a mouse or other user input device coupled to system 200. Accordingly, it may be assumed that the remaining variables in the list that were not selected by the user in this example are controllable variables associated with the well(s).

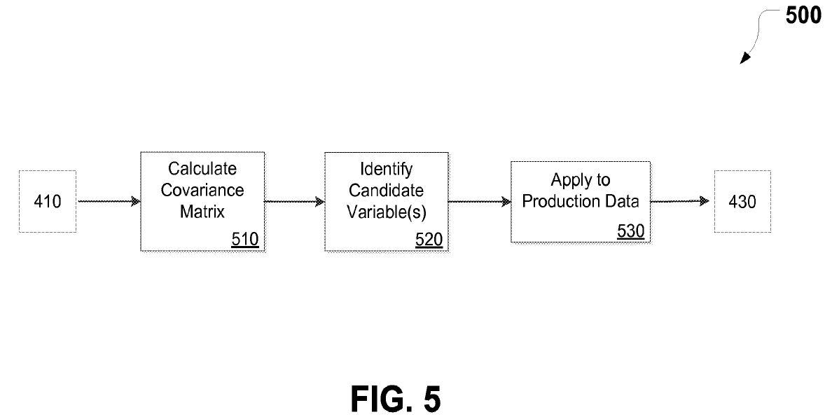

The uncontrollable variables that are identified in step 410 may then be used in step 420 for normalizing the well production data 302. In an embodiment, the normalization in step 420 may be based on correlations between one or more of the uncontrollable variables and production, as will be described in further detail below with respect to FIG. 5.

FIG. 5 is a flow diagram of an exemplary process 500 for normalizing uncontrollable variables identified in step 410 of FIG. 4, as described above. Thus, process 500 may be used, for example, to implement step 420 of FIG. 4. As shown in FIG. 5, process 500 includes steps 510, 520 and 530. Step 510 includes, for example, calculating a covariance matrix for the production data based on the identified uncontrollable variables. In step 520, the covariance matrix is used to identify one or more of the uncontrollable variables as candidates for purposes of normalizing the production data. For example, the candidate variable identified in step 520 may be the bottom hole pressure (BHP) associated with the subsurface reservoir formation. As there is a strong correlation between BHP and oil viscosity variations within the reservoir, and such variations are known to impact production, the BHP variable may be applied in step 530 to the production data so as to normalize the production data in terms of BHP. The normalized data that may be produced by step 530 in this example may be a well productivity index. The well productivity index may be calculated by, for example, dividing daily production by the BHP to result in normalized production, e.g., as expressed in oilfield units of bbl/day/psi. An advantage of such a normalized value is to allow for a more representative comparison of production among multiple wells.

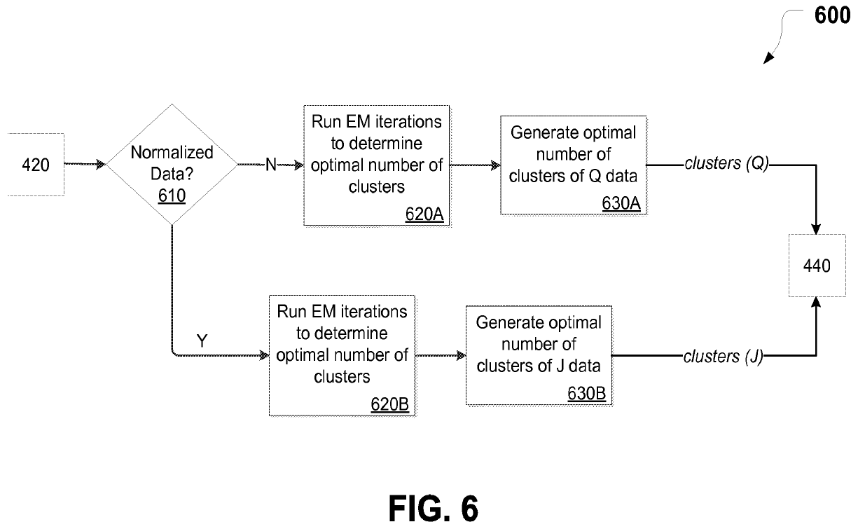

Referring back to process 400 of FIG. 4, once the data has been normalized in step 420, e.g., using process 500 of FIG. 5, as described above, process 400 proceeds to step 430, which includes generating clusters of the normalized production data based on the uncontrollable variables. However, it should be noted that the data transformation techniques disclosed herein are not intended to be limited to the normalization described above and that these techniques may be applied for transforming production data without such normalization, e.g., in cases where normalization may not be necessary for the particular implementation or given the type of production data being transformed. The clustering in step 430 may be based on, for example, different non-linear association patterns identified within the well production data using the uncontrollable variables, e.g., regardless of whether or not the normalization in step 420 has been performed. In an embodiment, the uncontrollable variables used to identify such patterns may include one or more geographical and physical parameters associated with each of the one or more wells, as described above. In an embodiment, the optimal number of clusters to be generated in step 430 may be determined iteratively using an expectation-maximization (EM) algorithm, as illustrated in FIG. 6.

FIG. 6 is a flow diagram of an exemplary process 600 for implementing the clustering of the production data in step 430, e.g., based on the previously identified uncontrollable variables from step 410 of FIG. 4, as described above. As shown in FIG. 6, process 600 includes steps 610, 620A, 620B, 630A and 630B. Step 610 may include, for example, determining whether or not the production data has been normalized. If it is determined in step 610 that the production data has not been normalized, process 600 proceeds to steps 620A and 630A. Otherwise, process 600 proceeds to steps 620B and 630B for clustering normalized production data. Steps 620A and 620B may include, for example, determining an optimal number of clusters to be generated for the non-normalized production data and the normalized production data, respectively, based on a plurality of iterations of an EM algorithm, as described above. It should be appreciated that any of various well-known or proprietary EM algorithms may be used. Steps 630A and 630B may include generating the optimal number of clusters determined for the non-normalized production data (or “Q data”) and the normalized production data (or “J data”), respectively.

Referring back to process 400 of FIG. 4, once the clusters have been generated in step 430 (e.g., using process 600 of FIG. 6, as described above), process 400 proceeds to step 440, in which the clusters may be validated. In an embodiment, the clusters may be validated based on one or more membership rules that are defined for each cluster. The membership rules for each of the clusters may be defined based on, for example, data associations identified from a classification analysis of the production data within each cluster. Such rules may specify, for example, that the various clusters do not conflict with each other and that the clusters cover all of the production data being analyzed. In an embodiment, the classification analysis may be performed using any of various classifier algorithms. In one example, such a classifier algorithm may be used to perform a classification and regression tree (“CART”) analysis on the production data. Such a CART analysis may involve, for example, the use of a classification or regression tree as part of a binary recursive partitioning algorithm or binary splitting process where parent nodes within the tree may be split into multiple child nodes. The rules generated by the classifier in this example may also be checked for quality and validity according to predetermined validation tolerances. Through validation, the cluster definitions may be refined into a set of well-defined membership rules.

After the clusters are validated, they may be finalized in step 450. In an embodiment, the clusters may be finalized based on a mean and a standard deviation calculated for the production data within each cluster. Referring back to data transformation process 300 of FIG. 3, the finalized clusters in this example may represent the clusters 315 that are output by the pre-processing stage 310 and provided as input to the response standardization stage 320, as described above. As will be described in further detail below with respect to FIG. 7, a number of steps may be performed to standardize the pre-processed production data within each of the finalized clusters in order to prepare the data for use in predictive modeling.

FIG. 7 is a flow diagram of an exemplary process 700 for standardizing the pre-processed production data (e.g., normalized production data) following the pre-processing stage 310 of FIG. 3 and the corresponding steps of FIG. 4, as described above. As shown in FIG. 7, process 700 includes steps 710, 720, 730 and 740. Process 700 begins in step 710, which includes removing outliers from each of clusters 315 according to one or more predetermined outlier tolerances or rules. Such tolerances may be used to identify data values within each cluster that fall outside of an expected range. For example, a predetermined range of tolerance values may be associated with each cluster, based on the particular data values within that cluster. Alternatively, such a predetermined tolerance range may be generalized for all of the clusters and independent of the data values that are specific to any one cluster. Any outlier data that is identified using such tolerance ranges may be removed, for example, to avoid introducing extra noise in the predictive model that will eventually incorporate the data. In this way, the production data within each of the clusters may be refined.

Once outliers are removed, process 700 proceeds to step 720, which includes calculating clustering parameters for each of clusters 315. In an embodiment, the calculated clustering parameters include a measure of central tendency (e.g., a mean or average) and a measure of dispersion (e.g., standard deviation) of the refined production data within each cluster. The calculated clustering parameters may help to characterize the clusters for standardization purposes. The calculated clustering parameters are then used in step 730 to standardize the response. Step 730 may include, for example, standardizing the response by centering and/or scaling the refined production data within each cluster based on the corresponding clustering parameters. Such standardization may help, for example, to make the different clusters more comparable, e.g., for visualization purposes.

Process 700 then proceeds to step 740, which includes generating transactional model data based on the standardized response produced in step 730. In an embodiment, the transactional data may be generated by transforming the scaled production data from step 730 into transactional data for inclusion in a predictive model. The transformed data may be in the form of a time series of production data. As described above, the predictive model may use the transformed time series production data to estimate future hydrocarbon production from the one or more wells within the hydrocarbon producing field or region of interest.

The above-described data transformation techniques allow well production data to be transformed such that uncontrollable variables impacting production are incorporated into the transactional data to be used for predictive modeling. Thus, advantages of the disclosed techniques include, but are not limited to, improving comparative analysis of production between different wells by grouping data into like statistical character and accounting for variations in production data due to uncontrollable variables, improving data quality by removing irrelevant outliers, and improving the detectability of causal variables in the predictive model by magnifying their impact on production through data standardization. Accordingly, the resulting predictive model may be more capable of accurately detecting and accounting for impact of controllable variables.

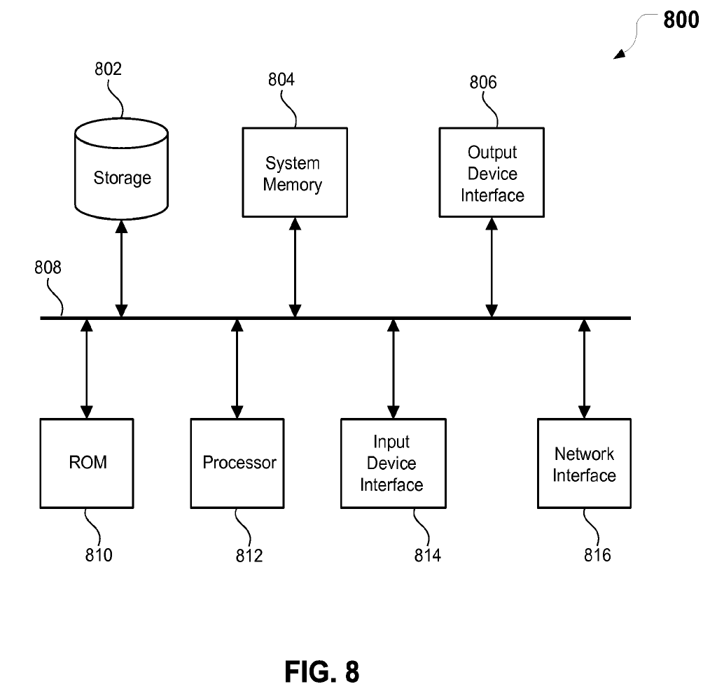

FIG. 8 is a block diagram of an exemplary computer system 800 in which embodiments of the present disclosure may be implemented. For example, the components of system 200 of FIG. 2 in addition to the above-described steps of processes 300, 400, 500, 600 and 700 of FIGS. 3-7, respectively, may be implemented using system 800. System 800 can be a computer, phone, PDA, or any other type of electronic device. Such an electronic device includes various types of computer readable media and interfaces for various other types of computer readable media. As shown in FIG. 8, system 800 includes a permanent storage device 802, a system memory 804, an output device interface 806, a system communications bus 808, a read-only memory (ROM) 810, processing unit(s) 812, an input device interface 814, and a network interface 816.

Bus 808 collectively represents all system, peripheral, and chipset buses that communicatively connect the numerous internal devices of system 800. For instance, bus 808 communicatively connects processing unit(s) 812 with ROM 810, system memory 804, and permanent storage device 802.

From these various memory units, processing unit(s) 812 retrieves instructions to execute and data to process in order to execute the processes of the subject disclosure. The processing unit(s) can be a single processor or a multi-core processor in different implementations.

ROM 810 stores static data and instructions that are needed by processing unit(s) 812 and other modules of system 800. Permanent storage device 802, on the other hand, is a read-and-write memory device. This device is a non-volatile memory unit that stores instructions and data even when system 800 is off. Some implementations of the subject disclosure use a mass-storage device (such as a magnetic or optical disk and its corresponding disk drive) as permanent storage device 802.

Other implementations use a removable storage device (such as a floppy disk, flash drive, and its corresponding disk drive) as permanent storage device 802. Like permanent storage device 802, system memory 804 is a read-and-write memory device. However, unlike storage device 802, system memory 804 is a volatile read-and-write memory, such as random access memory. System memory 804 stores some of the instructions and data that the processor needs at runtime. In some implementations, the processes of the subject disclosure are stored in system memory 804, permanent storage device 802, and/or ROM 810. For example, the various memory units include instructions for computer aided pipe string design based on existing string designs in accordance with some implementations. From these various memory units, processing unit(s) 812 retrieves instructions to execute and data to process in order to execute the processes of some implementations.

Bus 808 also connects to input and output device interfaces 814 and 806. Input device interface 814 enables the user to communicate information and select commands to the system 800. Input devices used with input device interface 814 include, for example, alphanumeric, QWERTY, or T9 keyboards, microphones, and pointing devices (also called “cursor control devices”). Output device interfaces 806 enables, for example, the display of images generated by the system 800. Output devices used with output device interface 806 include, for example, printers and display devices, such as cathode ray tubes (CRT) or liquid crystal displays (LCD). Some implementations include devices such as a touchscreen that functions as both input and output devices. It should be appreciated that embodiments of the present disclosure may be implemented using a computer including any of various types of input and output devices for enabling interaction with a user. Such interaction may include feedback to or from the user in different forms of sensory feedback including, but not limited to, visual feedback, auditory feedback, or tactile feedback. Further, input from the user can be received in any form including, but not limited to, acoustic, speech, or tactile input. Additionally, interaction with the user may include transmitting and receiving different types of information, e.g., in the form of documents, to and from the user via the above-described interfaces.

Also, as shown in FIG. 8, bus 808 also couples system 800 to a public or private network (not shown) or combination of networks through a network interface 816. Such a network may include, for example, a local area network (“LAN”), such as an Intranet, or a wide area network (“WAN”), such as the Internet. Any or all components of system 800 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself. Accordingly, the steps of method 700 of FIG. 7, as described above, may be implemented using system 800 or any computer system having processing circuitry or a computer program product including instructions stored therein, which, when executed by at least one processor, causes the processor to perform functions relating to these methods.

As used in this specification and any claims of this application, the terms “computer”, “server”, “processor”, and “memory” all refer to electronic or other technological devices. These terms exclude people or groups of people. As used herein, the terms “computer readable medium” and “computer readable media” refer generally to tangible, physical, and non-transitory electronic storage mediums that store information in a form that is readable by a computer.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., a web page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Furthermore, the exemplary methodologies described herein may be implemented by a system including processing circuitry or a computer program product including instructions which, when executed by at least one processor, causes the processor to perform any of the methodology described herein.

Embodiments of the present disclosure are particularly useful for transforming well production data for use in predictive modeling. As described above, a computer-implemented method of transforming well production data for predictive modeling may include: obtaining production data aggregated over a period of time for one or more wells in a hydrocarbon producing field, the aggregated production data including a series of production values for the one or more wells at predetermined increments during the period of time; pre-processing the obtained production data to generate clusters of the production data, based on a set of uncontrollable production variables identified for the one or more wells; standardizing the pre-processed production data within each of the clusters based on clustering parameters calculated for each cluster; and generating transactional data to be used in a predictive model for estimating production from the one or more wells, based on the standardized production data within each of the clusters. Further, a computer-readable storage medium with instructions stored therein has been described, where the instructions when executed by a computer cause the computer to perform a plurality of functions, including functions to: obtain production data aggregated over a period of time for one or more wells in a hydrocarbon producing field, the aggregated production data including a series of production values for the one or more wells at predetermined increments during the period of time; pre-process the obtained production data to generate clusters of the production data, based on a set of uncontrollable production variables identified for the one or more wells; standardize the pre-processed production data within each of the clusters based on clustering parameters calculated for each cluster; and generate transactional data to be used in a predictive model for estimating production from the one or more wells, based on the standardized production data within each of the clusters.

For the foregoing embodiments, the uncontrollable variables may include one or more geographical or physical parameters associated with each of the one or more wells, and the one or more geographical or physical parameters may include one or more of a geographic location of each of the one or more wells, a total vertical depth of a wellbore drilled at each of the one or more wells, and a bottom hole reservoir pressure within the wellbore at each of the one or more wells. Further, such embodiments may include any one of the following functions, operations or elements, alone or in combination with each other: normalizing the production data based on correlations between one or more of the uncontrollable variables and the production data; generating clusters of the normalized production data based on the uncontrollable variables; defining membership rules for each of the clusters, based on data associations identified from a classification analysis of the normalized production data within each cluster; validating each of the clusters based on the membership rules defined for each cluster; and finalizing the validated clusters based on a mean and a standard deviation calculated for the normalized production data within each of the clusters.

Normalizing may include: calculating a covariance matrix for the production data based on the uncontrollable variables; identifying candidate variables from among the uncontrollable variables for normalization of the production data, based on the calculated covariance matrix; and normalizing the production data based on the identified candidate variables. Generating clusters may include: determining an optimal number of clusters to be generated based on a plurality of iterations of an expectation-maximization algorithm; and generating the optimal number of clusters of the normalized production data based on the determination. The clusters of the normalized production data may be used to identify non-linear association patterns within the production data, based on the uncontrollable production variables. Standardizing the production data may include: refining the normalized production data within each of the finalized clusters by removing outliers from each cluster according to a predetermined outlier tolerance range; calculating the clustering parameters for each cluster based on the refined production data; and scaling the refined production data within each cluster based on the corresponding clustering parameters. Generating transactional data may include transforming the scaled production data into the transactional data for inclusion in the predictive model. The calculated clustering parameters may include a measure of central tendency and a measure of dispersion of the refined production data within each cluster.

Likewise, a system for transforming well production data for use in predictive modeling has been described and includes at least one processor and a memory coupled to the processor that has instructions stored therein, which when executed by the processor, cause the processor to perform functions, including functions to: obtain production data aggregated over a period of time for one or more wells in a hydrocarbon producing field, the aggregated production data including a series of production values for the one or more wells at predetermined increments during the period of time; pre-process the obtained production data to generate clusters of the production data, based on a set of uncontrollable production variables identified for the one or more wells; standardize the pre-processed production data within each of the clusters based on clustering parameters calculated for each cluster; and generate transactional data to be used in a predictive model for estimating production from the one or more wells, based on the standardized production data within each of the clusters.

For the foregoing embodiments, the uncontrollable variables in the system may include one or more geographical or physical parameters associated with each of the one or more wells. The one or more geographical or physical parameters may include one or more of a geographic location of each of the one or more wells, a total vertical depth of a wellbore drilled at each of the one or more wells, and a bottom hole reservoir pressure within the wellbore at each of the one or more wells. Further, the functions performed by the processor may further include, either alone or in combination with each other, function to: normalize the production data based on correlations between one or more of the uncontrollable variables and the production data; generate clusters of the normalized production data based on the uncontrollable variables, where the clusters of the normalized production data may be used to identify non-linear association patterns within the production data based on the uncontrollable production variables; calculate a covariance matrix for the production data based on the uncontrollable variables; identify candidate variables from among the uncontrollable variables for normalization of the production data, based on the calculated covariance matrix; normalize the production data based on the identified candidate variables; determine an optimal number of clusters to be generated based on a plurality of iterations of an expectation-maximization algorithm; generate the optimal number of clusters of the normalized production data based on the determination; define membership rules for each of the clusters, based on data associations identified from a classification analysis of the normalized production data within each cluster; validate each of the clusters based on the membership rules defined for each cluster; finalize the validated clusters based on a mean and a standard deviation calculated for the normalized production data within each of the clusters; refine the normalized production data within each of the finalized clusters by removing outliers from each cluster according to a predetermined outlier tolerance range; calculate the clustering parameters for each cluster based on the refined production data, the calculated clustering parameters including a measure of central tendency and a measure of dispersion of the refined production data within each cluster; scale the refined production data within each cluster based on the corresponding clustering parameters; and transform the scaled production data into the transactional data for inclusion in the predictive model.

While specific details about the above embodiments have been described, the above hardware and software descriptions are intended merely as example embodiments and are not intended to limit the structure or implementation of the disclosed embodiments. For instance, although many other internal components of the system 800 are not shown, those of ordinary skill in the art will appreciate that such components and their interconnection are well known.

In addition, certain aspects of the disclosed embodiments, as outlined above, may be embodied in software that is executed using one or more processing units/components. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives, optical or magnetic disks, and the like, which may provide storage at any time for the software programming

Additionally, the flowchart and block diagrams in the figures illustrate the architecture, functionality, and operation of possible implementations of systems, methods and computer program products according to various embodiments of the present disclosure. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The above specific example embodiments are not intended to limit the scope of the claims. The example embodiments may be modified by including, excluding, or combining one or more features or functions described in the disclosure.

As used herein, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the embodiments in the form disclosed. Many modifications and variations will be apparent to those of ordinary skill in the art without departing from the scope and spirit of the disclosure. The illustrative embodiments described herein are provided to explain the principles of the disclosure and the practical application thereof, and to enable others of ordinary skill in the art to understand that the disclosed embodiments may be modified as desired for a particular implementation or use. The scope of the claims is intended to broadly cover the disclosed embodiments and any such modification.

What is claimed is:

1. A computer-implemented method of transforming well production data for predictive modeling, the method comprising:
obtaining, by a computer system, production data aggregated over a period of time for one or more wells in a hydrocarbon producing field, the aggregated production data including a series of production values for the one or more wells at predetermined increments during the period of time;
pre-processing the obtained production data to generate clusters of the production data, based on a set of uncontrollable production variables identified for the one or more wells;
standardizing the pre-processed production data within each of the clusters based on clustering parameters calculated for each cluster; and
is generating transactional data to be used in a predictive model for estimating production from the one or more wells, based on the standardized production data within each of the clusters.

2. The method of claim 1, wherein the uncontrollable variables include one or more geographical or physical parameters associated with each of the one or more wells.

3. The method of claim 2, wherein the one or more geographical or physical parameters include one or more of a geographic location of each of the one or more wells, a total vertical depth of a wellbore drilled at each of the one or more wells, and a bottom hole reservoir pressure within the wellbore at each of the one or more wells.

4. The method of claim 1, wherein pre-processing further comprises:
normalizing the production data based on correlations between one or more of the uncontrollable variables and the production data; and
generating clusters of the normalized production data based on the uncontrollable variables.

5. The method of claim 4, wherein normalizing comprises:
calculating a covariance matrix for the production data based on the uncontrollable variables;
identifying candidate variables from among the uncontrollable variables for normalization of the production data, based on the calculated covariance matrix; and
normalizing the production data based on the identified candidate variables.

6. The method of claim 4, wherein generating clusters comprises:
determining an optimal number of clusters to be generated based on a plurality of iterations of an expectation-maximization algorithm; and
generating the optimal number of clusters of the normalized production data based on the determination.

7. The method of claim 4, wherein the clusters of the normalized production data are used to identify non-linear association patterns within the production data, based on the uncontrollable production variables.

8. The method of claim 4, further comprising:
defining membership rules for each of the clusters, based on data associations identified from a classification analysis of the normalized production data within each cluster;
validating each of the clusters based on the membership rules defined for each cluster; and
finalizing the validated clusters based on a mean and a standard deviation calculated for the normalized production data within each of the clusters.

9. The method of claim 8,
wherein standardizing comprises:
refining the normalized production data within each of the finalized clusters by removing outliers from each cluster according to a predetermined outlier tolerance range;
calculating the clustering parameters for each cluster based on the refined production data; and
scaling the refined production data within each cluster based on the corresponding clustering parameters, and
wherein generating transactional data comprises:
transforming the scaled production data into the transactional data for inclusion in the predictive model.

10. The method of claim 9, wherein the calculated clustering parameters include a measure of central tendency and a measure of dispersion of the refined production data within each cluster.

11. A system for transforming well production data for use in predictive modeling, the system comprising:
at least one processor; and
a memory coupled to the processor having instructions stored therein, which when executed by the processor, cause the processor to perform functions, including functions to:
obtain production data aggregated over a period of time for one or more wells in a hydrocarbon producing field, the aggregated production data including a series of production values for the one or more wells at predetermined increments during the period of time;
pre-process the obtained production data to generate clusters of the production data, based on a set of uncontrollable production variables identified for the one or more wells;
standardize the pre-processed production data within each of the clusters based on clustering parameters calculated for each cluster; and
generate transactional data to be used in a predictive model for estimating production from the one or more wells, based on the standardized production data within each of the clusters.

12. The system of claim 11, wherein the uncontrollable variables include one or more geographical or physical parameters associated with each of the one or more wells.

13. The system of claim 12, wherein the one or more geographical or physical parameters include one or more of a geographic location of each of the one or more wells, a total vertical depth of a wellbore drilled at each of the one or more wells, and a bottom hole reservoir pressure within the wellbore at each of the one or more wells.

14. The system of claim 11, wherein the functions performed by the processor further include functions to:
normalize the production data based on correlations between one or more of the uncontrollable variables and the production data; and
generate clusters of the normalized production data based on the uncontrollable variables.

15. The system of claim 14, wherein the functions performed by the processor further include functions to:
calculate a covariance matrix for the production data based on the uncontrollable variables;
identify candidate variables from among the uncontrollable variables for normalization of the production data, based on the calculated covariance matrix; and
normalize the production data based on the identified candidate variables.

16. The system of claim 14, wherein the functions performed by the processor further include functions to:
determine an optimal number of clusters to be generated based on a plurality of iterations of an expectation-maximization algorithm; and
generate the optimal number of clusters of the normalized production data based on the determination.

17. The system of claim 14, wherein the clusters of the normalized production data are used to identify non-linear association patterns within the production data, based on the uncontrollable production variables.

18. The system of claim 14, wherein the functions performed by the processor further include functions to:
define membership rules for each of the clusters, based on data associations identified from a classification analysis of the normalized production data within each cluster;
validate each of the clusters based on the membership rules defined for each cluster; and
finalize the validated clusters based on a mean and a standard deviation calculated for the normalized production data within each of the clusters.

19. The system of claim 18, wherein the functions performed by the processor further include functions to:
refine the normalized production data within each of the finalized clusters by removing outliers from each cluster according to a predetermined outlier tolerance range;
calculate the clustering parameters for each cluster based on the refined production data, the calculated clustering parameters including a measure of central tendency and a measure of dispersion of the refined production data within each cluster;
scale the refined production data within each cluster based on the corresponding clustering parameters; and
transform the scaled production data into the transactional data for inclusion in the predictive model.

20. A computer-readable storage medium having instructions stored therein, which when executed by a computer cause the computer to perform a plurality of functions, including functions to:
obtain production data aggregated over a period of time for one or more wells in a hydrocarbon producing field, the aggregated production data including a series of production values for the one or more wells at predetermined increments during the period of time;
pre-process the obtained production data to generate clusters of the production data, based on a set of uncontrollable production variables identified for the one or more wells;
standardize the pre-processed production data within each of the clusters based on clustering parameters calculated for each cluster; and
generate transactional data to be used in a predictive model for estimating production from the one or more wells, based on the standardized production data within each of the clusters.
